(19) United States
(12) Patent Application Publication
(10) Pub. No.: US 2002/0089979 A1
(43) Pub. Date: Jul. 11, 2002

(54) Communication security

(76) Inventor: Barbir Abdulkader, Nepean (CA)

Correspondence Address: Gowling Lafleur Henderson LLP, Suite 2600, 160 Elgin Street, Otawa, ON, KIP 1C3, CA

(21) Appl. No.: 10/014,475

(22) Filed: Dec. 14, 2001

(30) Foreign Application Priority Data
Dec. 29, 2000 (CA) 2,329,931

(51) Int. Cl. H04L 12/28

(52) U.S. Cl. 370/389

(57) ABSTRACT

This invention provides an improved mechanism to guard against message sequencing threats. It can be used in any system which makes use of a transform which uses a state machine such as encryption/decryption and compression/decompression systems, and where the transform and the inverse transform use the same state machines. The invention is implemented as a matching pair of applications at both ends of a transmission link. The transmitting end encodes the current value of a particular state using a one-way hash function and adds this value as a field in the transmitted packet. At the receiving end, the packet is passed to the decoding algorithm which derives the current value of the same state, and passes it through the same one way hash function. The receiver can compare the result of these operations with the value in the field sent by the transmitting end.

### FIELD OF INVENTION

The invention relates to the field of packet-based communications, particularly in the area of data security.

### BACKGROUND OF THE INVENTION

Typically, security of telecommunications links must deal with a number of different potential risks. These are described briefly below:

Type 1—Unauthorized Access Threat

Access control refers to the process of identifying legitimate access request and enables information exchange between local and authorized remote entities. Unauthorized access threat refers to the action that unauthorized entity can send fake or illegitimate messages in order to disturb the normal operation or to inject false information. Another type of illegal access is that an illegitimate entity sends a request for information it is not authorized to acquire.

Type 2—Modification of Information Threat

Modification of information attack refers to the act of an attacker altering legitimate messages when message authentication is absent. The intruder may alter in-transit legitimate messages generated by an authorized entity in such way that normal operation is jeopardized.

Type 3—Message Sequencing Threat

The message sequencing threat is the danger that messages may be arbitrarily re-sequenced, delayed, or replayed back such that normal operations are jeopardized. This is known as a playback attack.

Type 4—Disclosure of Information Threat

The disclosure threat is the danger that messages are obtained and disclosed to the unintended party. With lack of access control, any unauthorized party can contact and retrieve information or the attacker can eavesdrop on the links to steal the information

Type 5—Denial of Service Threat

Denial of service threat usually refers to the type of attack that stops or slows the normal operation of a network, link or node by diverting or depleting resources, or by exploiting certain implementation shortfall (weakness).

The area of particular concern here is to improve security against a Type 3—Message sequencing threat—a so-called ‘playback attack’.

One example of a protocol providing some defence against attacks such as those outlined above is the Internet Engineering Task Force (IETF)'s IP Security Protocol (IPSec). This is intended as the standard for secure communications on the Internet. As currently defined, IPSec comprises a basis for interoperably secured host-to-host communications, and thus provides protection for client protocols residing above the IP layer.

Typical encryption protocols are:

Data Encryption Standard (DES), is the name of the Federal Information Processing Standard (FIPS) 46-3, which describes the data encryption algorithm (DEA). The DEA is also defined in the ANSI standard X9.32, and is the best known and widely used symmetric algorithm in the world.

When used for communication, both sender and receiver must know the same secret key, which can be used to encrypt and decrypt the message, or to generate and verify a message authentication code (MAC). In a multi-user environment, secure key distribution may be difficult; public-key cryptography provides an ideal solution to this problem.

FIPS 46-3 includes a definition of triple-DES (DES3) in which the input data is, in effect, encrypted three times.

The protocol formats for IPSec's Authentication Header (AH) and IP Encapsulating Security Payload (ESP) are independent of the cryptographic algorithm, although certain algorithm sets are specified as mandatory for support in the interest of interoperability. Similarly, multiple algorithms are supported for key management purposes (establishing session keys for traffic protection), within IPSec's Internet Key Exchange (IKE) framework.

In IPSec, the fundamental concept of a Security Association (SA) is used in both of the protocols used to provide traffic security. The Internet Protocol (IP) Authentication Header (AH) provides connectionless integrity, data origin authentication and an optional anti-replay service. The Encapsulating Security Payload (ESP) protocol may provide confidentiality (through encryption), limited traffic flow confidentiality, as well as the services provided by the AH protocol. The two protocols may be used separately or together to provide a desired set of security services over the Internet. Actual encryption may make use of any suitable algorithm, e.g. Data Encryption Standard (DES), Triple DES (3DES).

In IPSec, the Security Association (SA) effectively identifies a simplex logical connection and is set up for each transaction. Each SA is uniquely identified in ways that need not concern us here but can be studied in RFC2401 and related documents.

The SA includes the provision of a sequence number, which, among other features, can be used to detect some forms of breach of security, in particular Type 3 threats outlined earlier.

One aspect of the sequence number is that it must consist of a non-recurring sequence of digits. The current implementation (which is defined in the standards) uses a simple monotonically increasing digit sequence. When the maximum number has been reached, to avoid repeating the sequence, the SA must be removed, and a new one negotiated. The maximum sequence length is restricted by the length (4 bytes) of the field allocated within the current protocol. With the increasingly high data transfer requirements, and wider bandwidth of the Internet, this limitation means that the SA must be negotiated quite frequently. With certain types of data traffic using small packets, the incremental overhead of 4 bytes for this sequence number is significant.

What is needed is a method or mechanism to improve security against a Type 3—Message sequencing threat or ‘playback attack’, while maintaining the same level of resistance to other types of threat as existing methods and mechanisms. Also needed is a means to ameliorate the effect of the limited lifetime of the connections defined by a given SA, and also to reduce the data overhead.

### SUMMARY OF THE INVENTION

This invention provides an improved mechanism to guard against a Type 3—Message sequencing threat or ‘playback attack’, and at the same time it provides additional benefits that are not attainable using the current implementations.

According to the Invention, there is provided a packet transmission system comprising: a transmitting device for incorporating a sequence field containing a pseudo-random value in data packets; and a receiving device for checking said pseudo-random value in said sequence field of said data packets, thereby permitting said receiving device to determine whether said data was sent by said transmitting device and whether the correct sequence of said data packets was maintained.

Other advantages, objects and features of the present invention will be readily apparent to those skilled in the art from a review of the following detailed description of preferred embodiments in conjunction with the accompanying drawings and claims

### BRIEF DESCRIPTION OF THE DRAWINGS

The embodiments of the invention will now be described with reference to the accompanying drawings, in which:

FIG. 1 shows a block diagram of one embodiment of the invention;

FIG. 2 is a flowchart of how a sequence field is computed at the transmitter; and

FIG. 3 is a flowchart of how a sequence field is computed and compared at the receiver.

### DETAILED DESCRIPTION OF THE INVENTION

Generally, the invention can be used in any system which makes use of a transform which uses a state machine. Examples of this are encryption/decryption and compression/decompression systems. In many cases the transform and the inverse transform use the same state machines. A state machine tracks the progress of an algorithm and maintains certain information about the data being manipulated. Within such state machines a state variable is one which changes in a pre-determinable way. An example of a ‘state’ in a compression system might be the number of occurrences of a particular string or letter for a particular transaction or file.

In summary the invention is implemented as a matching pair of applications at both ends of a transmission link. In preparing to transmit a particular packet of data, the transmitting end encodes the current value of a particular state using a one-way hash function, such as Message-Digest algorithm (MD-5), and adds this value as a field in the transmitted packet.

At the receiving end, the packet is passed to the decoding algorithm which, having decoded the contents, derives the current value of the same state, and passes it through the same one way hash function. The receiver can compare the result of these operations with the value in the field sent by the transmitting end. If the values match the message can be assumed to have been received in the correct sequence, otherwise the message is handled as an exception and appropriate measures taken. Since the state machine is not known to any attacker, and the seeding of any one-way hash algorithm is likewise unknown, it is difficult for such an attacker to create the same sequence of values and pass them off as genuine thus resulting in a successful ‘playback attack’ In the case of a state machine from an encryption implementation, the attacker would also need the key used to encrypt the data to arrive at the correct sequence of state values.

The implementation meets the requirement that the sequence must be non-repeating, but improves the situation by being unpredictable, or at least difficult to predict.

The technique is applicable to IPSec, but is equally useful in other security environments such as the Secure Socket Layer (SSL). Its application is independent of the type of transmission medium, and it may prove useful in wireless, optical and copper environments.

The main advantages may be summarised as:

Unlimited connection life, yet maintaining proof against ‘playback attack’.

Overhead optionally reduced or varied to match needs of user

Overhead optionally used to check key synchronisation and other security issues.

As will be apparent to those skilled in the art, the invention uses a combination of known elements and techniques to perform a task not previously implemented in the art.

Other aspects of the invention will be clear to those skilled in the art on examination of the figures and description following.

Playback attacks are typically protected against by the use of sequence numbers whose actual values are non-recurring. As mentioned earlier this is used in a typical implementation viz. IPSec, which has added restriction that the duration or lifetime of a particular connection must be restricted to prevent the simple monotonic sequence repeating.

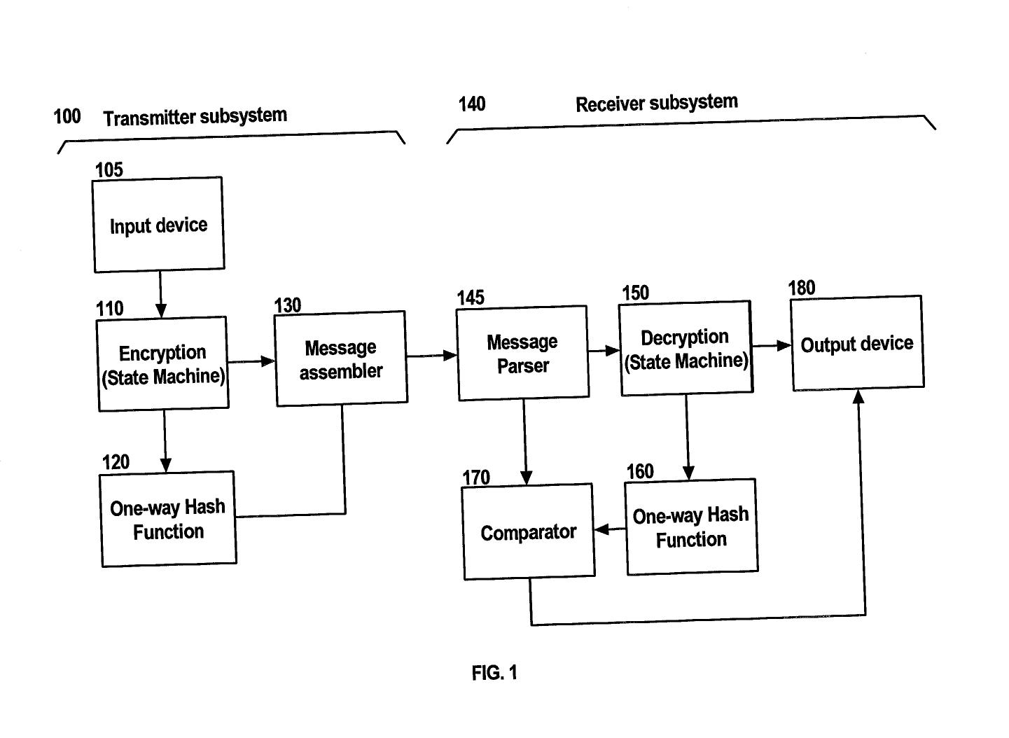

The present invention makes use of the fact that many useful transforms such as encryption algorithms are implemented using a state machine. This state machine must be implemented at both the transmitting end and the receiving end of the link, e.g., in both the encryption process and the decryption process. Put simply, the basis of the invention is to include in the data being transmitted a description of the current ‘state’ of the transform being used instead of a sequence number. This ‘state’ can then be checked during processing of the inverse transform e.g., decryption. Turning therefore to FIG. 1 we see in the transmitter subsystem 100, the input device 105 which passes data to an Encryption device 110 which is implemented using a State Machine. The encrypted data is passed to the message assembler in preparation for transmission. When a message is ready for transmission, the state information from the Encryption device 110 is passed through a One-way Hash Function 120 and the resulting value inserted in a field of the message assigned for this purpose. At the receiver subsystem 140, a message parser 145 passes the data to a Decryption device 150 implemented using the same State Machine as the Encryption device 110. The decrypted message is then passed to the output device 180. On completion of decryption the state information from the Decryption device is passed to another One-way Hash Function 160, having the same characteristics as the One-way Hash Function 120 at the Transmitter subsystem 100. The message parser 145 also passes the value of the field in the message assigned to contain the state to a Comparator 170 which takes the value resulting from the One-way Hash Function 160 and passes the result—same or different—to the output device for action as required.

For a secure encryption/decryption algorithm, it is known in the art that the sequence of states is very difficult or impossible to predict without access to the various keys. Therefore, it may be seen that the ability to recreate or predict a valid sequence of digits (or codes)in a sequence of messages is protected to the same degree as the data itself.

The one-way hash function is simply a fast cryptographic algorithm to convert a message of any length into a single string of digits, sometimes called a message digest. Since it is also necessary to ensure that the output values from this hashing function map into the available space in a logical/sensible manner the output of the hash function is selected to match the available field size in the packets being conveyed. An example of such a one-way hashing function is the Message-Digest algorithm (MD-5) as defined in the IETF RFC 1321.

The ‘state’ as modified by the hashing function is then performing the function of the sequence number, since its validity in terms of sequence can be checked. It is also part of an indefinite series that will essentially never repeat and therefore there is no need to limit the duration or data volume of a connection/session. In addition, the nature of the means by which the state is derived reduces the likelihood of a successful playback attack, since modern encryption algorithms may be used in the derivation of the sequence.

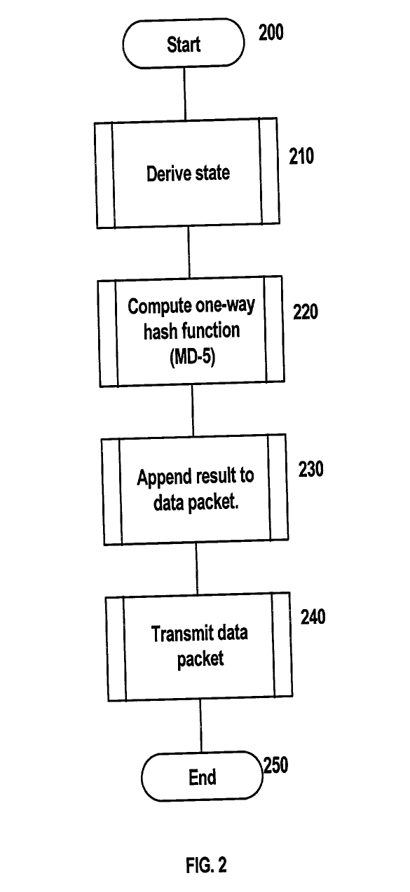

We refer now to FIG. 2, where the activity of the Transmitter subsystem is described in the form of a flowchart. As each message or packet is prepared for transmission, the subsystem starts a sequence 200. The first action is to derive the state 210 from an appropriate source, in the example above we used the example of encryption/decryption, although other algorithms also use state machine, e.g. data compressors. The state is then passed through a one-way hash function 220 and the result appended to the data packet 230 before being transmitted 240. Finally the subsystem ends the procedure 250.

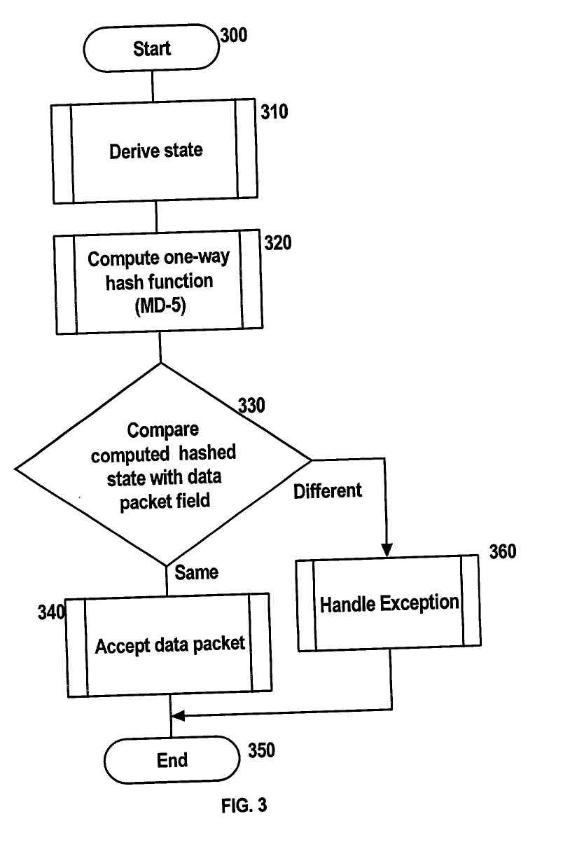

Turning now to FIG. 3 we describe the complementary receiving subsystem behaviour. When a data packet has been received, the data is passed to the decryption function and the state information derived from that function 310. The state is then passed through the one-way hash function 320 and the result compared 330 with the contents of the field in the data packet containing the sequence information. In the situation where the comparison is the same, the data packet is accepted 340, and in the case where there is a difference, some appropriate form of exception handling takes place 360. Finally the subsystem ends the procedure 350.

In one embodiment of the invention, possibly suitable for adoption within IPSec, the method requires identical one-way hashing algorithms to be associated with both the encryption and decryption functions, and the resultant sequence of values is passed through a modulo function (mod) to ensure that each value of the sequence produced by the one-way hash function can be contained within the 4 bytes (32 bits) already defined by the IPSec protocol.

In a further embodiment, each value of the sequence is restricted to some arbitrary number of bits (or likely bytes), comprising at least one byte (8 bits), but less than 4 bytes (32 bits), thereby potentially saving bandwidth since less data is required for the message overhead (which includes the sequence number or equivalent).

In yet another embodiment of the invention, use is made of the fact that the sequence relates to the encryption process and therefore that the inability of the receiver to correctly decrypt the data can be directly attributed to mismatch of keys, permitting the users to recover the connection more quickly than would otherwise be the case since no further analysis of the situation is required to determine cause of link failure.

In yet another embodiment, the sequence number field can be extended to include coded versions of other states of the encryption state machine (or rather the related processors and/or programs) and thus allow a simple encrypted dialogue between the encryption and decryption processes.

If this invention is to be used in existing standard protocols the relevant standards must permit a new version (or versions) of the protocol which use the new method or provide a means to allow this in the processes which handle the protocol.

In summary, the invention can be implemented for any security or other protocol for which implementation independent states are defined and where there might be the need to reduce the possibility of Type 3 security threats (playback attacks). In the particular case of IPSec, the invention, if adopted as part of the standard, permits a Security Association to be used for as long as needed, without an arbitrarily restricted lifetime. It also allows the network operator to diagnose certain types of problem more quickly than in the past. This aspect relates to the ability of the system signal that a particular sequence of states is not followed, inferring that the encrypt/decrypt algorithms or, more likely, keys do not match.

Numerous modifications, variations and adaptations may be made to the particular embodiments of the invention described above without departing from the scope of the invention which is defined in the claims.

What is claimed is:

1. A packet transmission system comprising:
a transmitting device for incorporating a sequence field containing a pseudo-random value in data packets; and
a receiving device for checking said pseudo-random value in said sequence field of said data packets, thereby permitting said receiving device to determine whether said data was sent by said transmitting device and whether the correct sequence of said data packets was maintained.

2. The system of claim 1 in which said transmitting device further comprises:
a transform function operating on said data using states; and
means to include said states of said transform function as said pseudo-random value in the said sequence field of said packet to be transmitted over said transmission medium.

3. The system of claim 2 in which said receiving device further comprises:
a second transform function using states; and
means to compare said states of said transform function contained in said sequence field of said packet received over said transmission medium with result of said second one-way hash function when used to encode said states of said second transform function, thereby permitting said receiving device to be assured that said packet was sent by said transmitting device.

4. The system of claim 3 in which said transmitting device further includes a one-way hash function to encode said states of said transform function

5. The system of claim 4 in which said receiving device further includes a second one-way hash function to encode said states of said second transform function

6. The system of claim 5 wherein said transform function and said second transform function are identical, thereby ensuring simpler matching of said states.

7. The system of claim 6 wherein said one-way hash function and said second one-way hash function are identical, thereby ensuring simpler matching of said states.

8. The system of claim 7 wherein the length of said included said states is varied to match the system needs, thereby allowing some savings in message overhead where said length is less than that assigned in existing protocols.

9. The system of claim 8 wherein said transform and said second transform are any algorithm using states in their implementation.

10. The system of claim 8 wherein said transform and said second transform are encryption algorithms.

11. The system of claim 8 wherein said transform and said second transform are compression algorithms.

12. The system of claim 10 wherein said state values are used to confirm synchronisation of encryption keys.

13. The system of claim 10 wherein said state values are further used to confirm other aspects of the operation of said encryption algorithms.
